(19) United States
(12) Patent Application Publication
(10) Pub. No.: US 2016/0154757 A1
(43) Pub. Date: Jun. 2, 2016

(54) INTERFACE SWITCH APPARATUS

(71) Applicants: Hong Fu Jin Precision Industry (WuHan) Co., Ltd., Wuhan (CN); Hon Hai Precision Industry Co., Ltd., New Taipei (TW)

(72) Inventors: DAO-WEI LI, Wuhan (CN); CHUN-SHENG CHEN, New Taipei (TW)

(21) Appl. No.: 14/606,146

(22) Filed: Jan. 27, 2015

(30) Foreign Application Priority Data
Dec. 1, 2014 (CN) 201410711364.0

(51) Int. Cl. G06F 13/40; G06F 13/42; G06F 1/32

(52) U.S. Cl. CPC G06F 13/4022; G06F 1/3287; G06F 1/3296; G06F 13/4282; G06F 13/4068

(57) ABSTRACT

An interface switch apparatus includes a first interface, a switch circuit, a second interface, and a south bridge chip. The first interface includes a first control signal output terminal, a second control signal output terminal, and a third control signal output terminal. The second interface includes an identifying signal output terminal. The south bridge chip includes an identifying signal input terminal. The first control signal output terminal, the second control signal output terminal, and the third control signal output terminal output control signals according to a device inserted in the first interface. The switch circuit receives the control signals, and outputs an identifying signal accordingly. The identifying signal output terminal and the identifying signal input terminal receives the identifying signal. The south bridge chip determines a type of the device inserted in the first interface by a voltage level of the identifying signal.

### CROSS-REFERENCE TO RELATED APPLICATIONS

This application claims priority to Chinese Patent Application No. 201410711364.0 filed on Dec. 1, 2014, the contents of which are incorporated by reference herein.

### FIELD

The subject matter herein generally relates to an interface switch apparatus.

### BACKGROUND

Printed circuit boards usually have interfaces supporting different kinds of storage devices and peripheral cards. For example, Socket2 and Socket3 are two kinds of interfaces defined by INTEL for different kinds of devices. Socket2 and Socket3 interfaces have different definitions for connecting pins. When a Socket2 device is inserted in Socket3 interface, the device cannot be identified by the computer system.

### BRIEF DESCRIPTION OF THE DRAWINGS

Implementations of the present technology will now be described, by way of example only, with reference to the attached figures.

FIG. 1 is a block diagram of an embodiment of an interface switch apparatus.

FIG. 2 is a circuit diagram of the interface switch apparatus of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

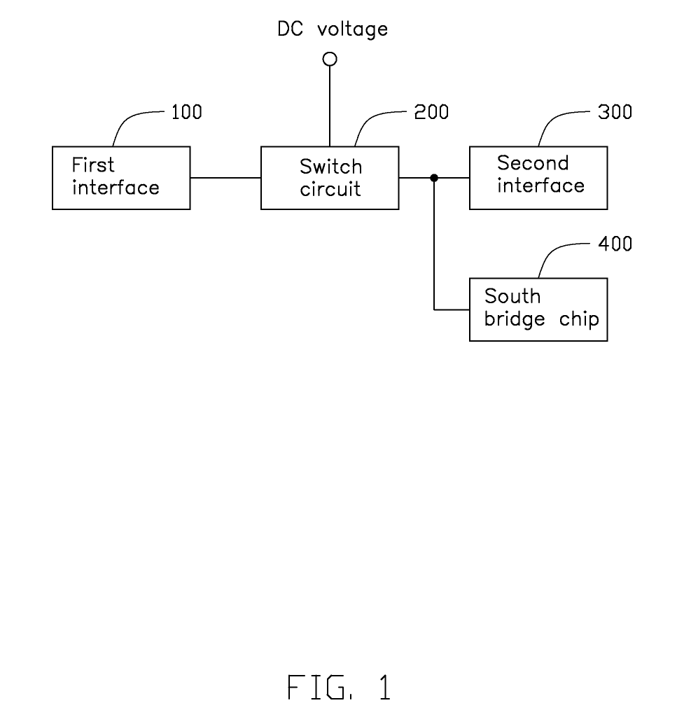

FIG. 1 illustrates an interface switch apparatus in accordance with an embodiment. The interface switch apparatus includes a first interface 100, a switch circuit 200, a second interface 300, and a south bridge chip 400.

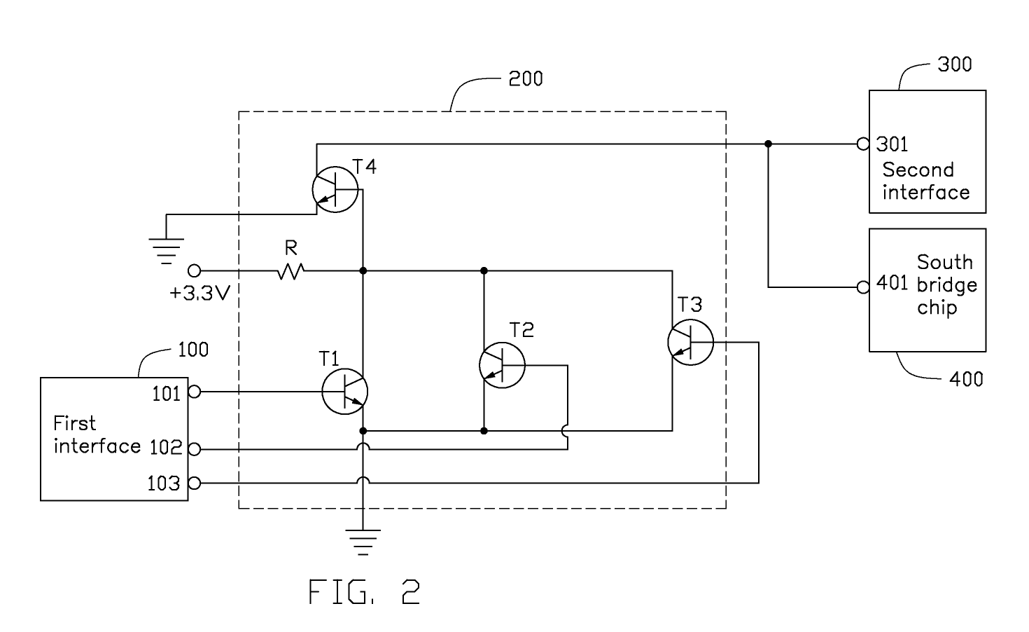

FIG. 2 illustrates that the first interface 100 includes a first control signal output terminal 101, a second control signal output terminal 102, and a third control signal output terminal 103. The second interface 300 includes an identifying signal output terminal 301. The south bridge chip 400 includes an identifying signal input terminal 401. In at least one embodiment, the first interface 100 is a Socket2 interface, and the second interface 300 is a Socket3 interface.

The switch circuit 200 includes a first switch T1, a second switch T2, a third switch T3, and a fourth switch T4. Each of the first switch T1, the second switch T2, the third switch T3, and the fourth switch T4 includes a first terminal, a second terminal, and a third terminal. In at least one embodiment, the first switch T1, the second switch T2, the third switch T3, and the fourth switch T4 are npn type transistors. The first terminal, the second terminal, and the third terminal are base, emitter, and collector respectively.

The first control signal output terminal 101, the second control signal output terminal 102, and the third control signal output terminal 103 are electrically coupled to the first terminals of the first switch T1, the second switch T2, and the third switch T3 respectively. The second terminals of the first switch T1, the second switch T2, and the third switch T3 are grounded. The third terminals of the first switch T1, the second switch T2, and the third switch T3 are electrically coupled to the first terminal of the fourth switch T4 and receive a DC voltage via a resistor R. The second terminal of the fourth switch T4 is grounded. The third terminal of the fourth switch T4 is electrically coupled to the identifying signal output terminal 301 and the identifying signal input terminal 401. In at least one embodiment, the DC voltage is +3.3 volts.

In use, when a serial advanced technology attachment (SATA) device is inserted in the first interface 100, the first control signal output terminal 101, the second control signal output terminal 102, and the third control signal output terminal 103 all output low voltage level control signals. The first terminals of the first switch T1, the second switch T2, and the third switch T3 receive the low voltage level control signals. The first switch T1, the second switch T2, and the third switch T3 all turn off. The first terminal of the fourth switch T4 receives the DC voltage via the resistor R. The fourth switch T4 turns on. The third terminal of the fourth switch T4 outputs a low voltage level identifying signal to the identifying signal output terminal 301 and the identifying signal input terminal 401. The south bridge chip 400 determines the device inserted in the first interface 100 is the SATA device by the low voltage level identifying signal.

When a peripheral component interconnect express (PCIE) device is inserted in the first interface 100, at least one of the first control signal output terminal 101, the second control signal output terminal 102, and the third control signal output terminal 103 outputs a high voltage level control signal. At least one first terminal of the first switch T1, the second switch T2, and the third switch T3 receives the high voltage level control signal. At least one of the first switch T1, the second switch T2, and the third switch T3 turns on. The first terminal of the fourth switch T4 is grounded via at least one of the first switch T1, the second switch T2, and the third switch T3. The fourth switch T4 turns off. The third terminal of the fourth switch T4 outputs a high voltage level identifying signal to the identifying signal output terminal 301 and the identifying signal input terminal 401. The south bridge chip 400 determines the device inserted in the first interface 100 is the PCIE device by the high voltage level identifying signal.

The embodiments shown and described above are only examples. Many details are often found in the art such as the other features of an interface switch apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An interface switch apparatus comprising:
a first interface comprising a first control signal output terminal, a second control signal output terminal, and a third control signal output terminal each configured to output a control signal according to a device inserted in the first interface;
a switch circuit configured to receive the control signals and output an identifying signal accordingly;
a second interface comprising an identifying signal output terminal configured to receive the identifying signal; and
a south bridge chip comprising an identifying signal input terminal configured to receive the identifying signal,
wherein the south bridge chip determines a type of the device inserted in the first interface by a voltage level of the identifying signal.

2. The interface switch apparatus of claim 1, wherein the switch circuit comprises a first switch, a second switch, a third switch, and a fourth switch; each of the first switch, the second switch, the third switch, and the fourth switch comprises a first terminal, a second terminal, and a third terminal; the first control signal output terminal, the second control signal output terminal, and the third control signal output terminal are electrically coupled to the first terminals of the first switch, the second switch, and the third switch respectively; the second terminals of the first switch, the second switch, and the third switch are grounded; the third terminals of the first switch, the second switch, and the third switch are electrically coupled to the first terminal of the fourth switch and receive a DC voltage; the second terminal of the fourth switch is grounded; and the third terminal of the fourth switch is electrically coupled to the identifying signal output terminal and the identifying signal input terminal.

3. The interface switch apparatus of claim 2, wherein the third terminals of the first switch, the second switch, and the third switch are electrically coupled together and receive the DC voltage via a resistor.

4. The interface switch apparatus of claim 2, wherein the first switch, the second switch, the third switch, and the fourth switch are npn type transistors; and the first terminal, the second terminal, and the third terminal are base, emitter, and collector respectively.

5. The interface switch apparatus of claim 4, wherein when a first device is inserted in the first interface, the first control signal output terminal, the second control signal output terminal, and the third control signal output terminal all output low voltage level control signals, the first switch, the second switch, and the third switch all turn off, the fourth switch turns on, the third terminal of the fourth switch outputs a low voltage level identifying signal to the identifying signal output terminal and the identifying signal input terminal; and the south bridge chip determines the device inserted in the first interface is the first device by the low voltage level identifying signal.

6. The interface switch apparatus of claim 5, wherein when a second device is inserted in the first interface, at least one of the first control signal output terminal, the second control signal output terminal, and the third control signal output terminal outputs a high voltage level control signal, at least one of the first switch, the second switch, and the third switch turns on, the fourth switch turns off, the third terminal of the fourth switch outputs a high voltage level identifying signal to the identifying signal output terminal and the identifying signal input terminal; and the south bridge chip determines the device inserted in the first interface is the second device by the high voltage level identifying signal.

7. The interface switch apparatus of claim 6, wherein the first device is a serial advanced technology attachment (SATA) device; and the second device is a peripheral component interconnect express (PCIE) device.

8. The interface switch apparatus of claim 2, wherein the DC voltage is +3.3 volts.

9. The interface switch apparatus of claim 1, wherein the first interface is a Socket2 interface, and the second interface is a Socket3 interface.

10. An interface switch apparatus comprising:
a first interface comprising a first control signal output terminal, a second control signal output terminal, and a third control signal output terminal each configured to output a control signal according to a device inserted in the first interface;
a switch circuit comprising a first switch, a second switch, a third switch, and a fourth switch; each of the first switch, the second switch, the third switch, and the fourth switch comprises a first terminal and a third terminal;
wherein the first terminals of the first switch, the second switch, and the third switch are electrically coupled to the first control signal output terminal, the second control signal output terminal, and the third control signal output terminal respectively for receiving the control signals; the third terminal of the fourth switch outputs an identifying signal according to the control signals;
a second interface comprising an identifying signal output terminal configured to receive the identifying signal; and
a south bridge chip comprising an identifying signal input terminal configured to receive the identifying signal,
wherein when a first device is inserted in the first interface, the first control signal output terminal, the second control signal output terminal, and the third control signal output terminal all output low voltage level control signals, the first switch, the second switch, and the third switch all turn off, the fourth switch turns on, the third terminal of the fourth switch outputs a low voltage level identifying signal to the identifying signal output terminal and the identifying signal input terminal; and the south bridge chip determines the device inserted in the first interface is the first device by the low voltage level identifying signal; and
wherein when a second device is inserted in the first interface, at least one of the first control signal output terminal, the second control signal output terminal, and the third control signal output terminal outputs a high voltage level control signal, at least one of the first switch, the second switch, and the third switch turns on, the fourth switch turns off, the third terminal of the fourth switch outputs a high voltage level identifying signal to the identifying signal output terminal and the identifying signal input terminal; and the south bridge chip determines the device inserted in the first interface is the second device by the high voltage level identifying signal.

11. The interface switch apparatus of claim 10, wherein each of the first switch, the second switch, the third switch, and the fourth switch further comprises a second terminal; the second terminals of the first switch, the second switch, and the third switch are grounded; the third terminals of the first switch, the second switch, and the third switch are electrically coupled to the first terminal of the fourth switch and receive a DC voltage; and the second terminal of the fourth switch is grounded.

12. The interface switch apparatus of claim 11, wherein the third terminals of the first switch, the second switch, and the third switch are electrically coupled together and receive the DC voltage via a resistor.

13. The interface switch apparatus of claim 11, wherein the DC voltage is +3.3 volts.

14. The interface switch apparatus of claim 10, wherein the first switch, the second switch, the third switch, and the fourth switch are npn type transistors; and the first terminal, the second terminal, and the third terminal are base, emitter, and collector respectively.

15. The interface switch apparatus of claim 10, wherein the first device is a serial advanced technology attachment (SATA) device; and the second device is a peripheral component interconnect express (PCIE) device.

16. The interface switch apparatus of claim 10, wherein the first interface is a Socket2 interface, and the second interface is a Socket3 interface.
